(19) United States
(12) Patent Application Publication
(10) Pub. No.: US 2023/0238807 A1
(43) Pub. Date: Jul. 27, 2023

(54) POWER DISTRIBUTION MODULE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Yuki FUJIMURA, Osaka-shi, Osaka (JP); Fumihiro KUZUHARA, Osaka-shi, Osaka (JP); Yusuke ISAJI, Osaka-shi, Osaka (JP); Takafumi KAWAKAMI, Osaka-shi, Osaka (JP); Masayoshi HIROTA, Yokkaichi-shi, Mie (JP); Kazuki MASUDA, Yokkaichi-shi, Mie (JP)

(21) Appl. No.: 18/003,618

(22) PCT Filed: Jun. 17, 2021
(86) PCT No.: PCT/JP2021/022998

§ 371 Date: Dec. 28, 2022

(30) Foreign Application Priority Data
Jul. 8, 2020 (JP) 2020-117555

(51) Int. Cl. H02J 7/00; B60L 3/00

(52) U.S. Cl. CPC H02J 7/0031; H02J 7/0063; H02J 7/0047; B60L 3/0023; H02J 2207/20

(57) ABSTRACT

A power distribution module including: a power line connecting between a battery and a load; a main relay connected to the power line; an active fuse connected to the power line on the battery side relative to the main relay; a first voltage converter connected to the power line on the load side relative to the main relay; an abnormality detection unit configured to detect an abnormality of the power line; and a first driving/control wiring extending from the first voltage converter and connected to the active fuse, wherein a first control unit mounted on the first voltage converter transmits a control signal for disconnecting the active fuse when the abnormality detection unit detects an abnormality of the power line, and the active fuse is disconnected.

### CROSS-REFERENCE TO RELATED APPLICATIONS

This application is the U.S. national stage of PCT/JP2021/022998 filed on Jun. 17, 2021, which claims priority of Japanese Patent Application No. JP 2020-117555 filed on Jul. 8, 2020, the contents of which are incorporated herein.

### TECHNICAL FIELD

The present disclosure relates to a power distribution module connected between a battery and a load.

### BACKGROUND

In a vehicle such as an electric car or a hybrid car, a main relay is used to interrupt a power line between a battery formed by high-voltage secondary cells and a load such as a motor. Then, when driving of the load is stopped or some sort of abnormality occurs in a circuit near the battery, the power line between the battery and the load is shut off by the main relay so as to stop a current from the battery from being supplied to the load.

Incidentally, when some sort of abnormality occurs in a circuit near the battery and the power line is shut off by the main relay, the main relay is turned off while a current is flowing through the power line, and thus there is a concern that arc discharge will occur between contacts of the main relay and that it will not be possible to shut off the current. Thus, JP H7-274378A proposes a structure in which an active fuse that can be disconnected using a control signal is provided on the power line between the battery and the main relay. Thus, after the power line between the battery and the main relay has been shut off by the active fuse in response to the occurrence of an abnormality, the main relay can be turned off. As a result, a current is not being supplied via the power line when the main relay is turned off, and arc discharge between contacts of the main relay can be prevented.

However, in the conventional example disclosed in JP H7-274378A, in order to control disconnection of the active fuse, among other things, new driving and control wirings need to be added between the active fuse and a vehicle control unit, and changes to the configuration of the vehicle control unit need to be made, which inevitably increases the cost. Also, the length of a conductive line that joins the active fuse provided near the battery and the vehicle control unit provided at a position comparatively far from the battery is long, and thus there is also an increased risk of an issue such as the conductive line breaking. Therefore, there is the inherent issue of not being able to sufficiently guarantee proper operation reliability of the active fuse.

Thus, a power distribution module with a novel structure that can disconnect a main relay from a battery with excellent reliability and cost performance is disclosed.

### SUMMARY

A power distribution model of the present disclosure is a power distribution module including: a power line connecting between a battery and a load; a main relay connected to the power line; an active fuse connected to the power line on the battery side relative to the main relay; a first voltage converter connected to the power line on the load side relative to the main relay; an abnormality detection unit configured to detect an abnormality of the power line; a first driving/control wiring extending from the first voltage converter and connected to the active fuse and the abnormality detection unit; and a case, wherein the case houses the power line, the main relay, the active fuse, the first voltage converter, the abnormality detection unit, and the first driving/control wiring, and a first control unit mounted on the first voltage converter and different from a control unit for controlling the main relay transmits a control signal for disconnecting the active fuse through the first driving/control wiring when the abnormality detection unit detects an abnormality of the power line via the first driving/control wiring, and the active fuse is disconnected.

### Advantageous Effects

With the present disclosure, a power distribution module with a novel structure that can disconnect a main relay from a battery with excellent reliability and cost performance can be provided.

### BRIEF DESCRIPTION OF DRAWINGS

FIG. 1 is a plan view showing a power distribution module according to Embodiment 1 of the present disclosure.

FIG. 2 is a diagram schematically showing an electrical structure of the power distribution module on a path between a battery and a load.

### DETAILED DESCRIPTION OF PREFERRED EMBODIMENTS

### Description of Embodiments of Present Disclosure

First, embodiments of the present disclosure will be listed and described below.

In accordance with a first aspect, a power distribution module of the present disclosure is a power distribution module including: a power line connecting between a battery and a load; a main relay connected to the power line; an active fuse connected to the power line on the battery side relative to the main relay; a first voltage converter connected to the power line on the load side relative to the main relay; an abnormality detection unit configured to detect an abnormality of the power line; and a first driving/control wiring extending from the first voltage converter and connected to the active fuse, wherein a first control unit mounted on the first voltage converter transmits a control signal for disconnecting the active fuse when the abnormality detection unit detects an abnormality of the power line, and the active fuse is disconnected.

With the power distribution module of the present disclosure, the active fuse connected to the power line on the battery side relative to the main relay operates based on a control signal when the abnormality detection unit detects an abnormality of the power line. Thus, the main relay can be turned off after the power line between the battery and the main relay has been shut off by the active fuse in response to the occurrence of an abnormality. As a result, a current is not being supplied through the power line when the main relay is turned off, and arc discharge can be prevented from occurring between contacts of the main relay. Thus, an increase in the distance between contacts for arc extinguishment or a specially structured main relay provided with a permanent magnet is not required, and a comparatively cheap main relay can be employed, which reduces the cost.

Also, the active fuse is connected to the first driving/control wiring extending from the first voltage converter mounted in the power distribution module. Thus, the driving/control wiring for the active fuse can be configured in the power distribution module and compared to a conventional structure in which it is necessary to route a driving/control wiring between a vehicle control unit and the active fuse, the driving/control wiring for the active fuse can be made shorter. Accordingly, the cost can be reduced, the risk of an issue such as breaking of the driving/control wiring can be advantageously reduced, and the operation reliability of the active fuse can be improved.

Furthermore, operation of the active fuse can be controlled using the first control unit mounted on the first voltage converter, and thus a configuration for controlling operation of the active fuse can be constructed in the power distribution module. Thus, the need for adjusting or changing external devices such as the vehicle control unit can be reduced, and a corresponding reduction in cost can be also be achieved. In addition, the driving/control wiring for the active fuse is configured inside the power distribution module, and thus, even if an issue was to occur with the vehicle control unit, it is possible to cause the active fuse to operate when an abnormality occurs on the power line. Thus, the operation reliability of the active fuse can be further advantageously improved.

Note that the abnormality detection unit that detects an abnormality of the power line can be configured using a current sensor, a voltage sensor, or the like. Also, the active fuse may be any fuse provided that it can be disconnected based on a control signal from an external device.

In a second aspect, it is preferable that the power distribution module further includes: a second voltage converter connected to the power line on the load side relative to the main relay; and a second driving/control wiring extending from the second voltage converter and connected to the active fuse, wherein a second control unit mounted on the second voltage converter transmits a control signal for disconnecting the active fuse when the abnormality detection unit detects an abnormality of the power line, and the active fuse is disconnected. The second driving/control wiring is also connected to the active fuse from the second voltage converter mounted in the power distribution module, and operation of the active fuse can also be controlled by the second control unit mounted on the second voltage converter. Thus, even if an issue was to occur with one of the first and second control units, the other control unit can reliably operate the active fuse when an abnormality occurs on the power line. Therefore, the operation reliability of the active fuse can be further improved. Furthermore, similarly to the first driving/control wiring, the second driving/control wiring extending from the second voltage converted mounted in the power distribution module can be shortened, and thus the risk of breaking and the like occurring can also be advantageously reduced.

In a third aspect, according to the first aspect, it is preferable that the power distribution model further includes a case, wherein the case houses the power line, the main relay, the active fuse, the first voltage converter, the abnormality detection unit, and the first driving/control wiring. Constituent elements of the power distribution module of the present disclosure are housed in the case, and thus the handleability of the power distribution module and ease of attaching the power distribution module to a vehicle can be advantageously improved.

In a fourth aspect, according to the second aspect, it is preferable that the power distribution model further includes a case, wherein the case houses the power line, the main relay, the active fuse, the first voltage converter, the abnormality detection unit, the first driving/control wiring, the second voltage converter, and the second driving/control wiring. Constituent elements of the power distribution module of the present disclosure are housed in the case, and thus the handleability of the power distribution module and ease of attaching the power distribution module to a vehicle can be advantageously improved.

In a fifth aspect, it is preferable that the active fuse is a pyro fuse. The active fuse is formed by a pyro fuse, and thus an explosive force caused by ignition of an explosive can be used to instantaneously and reliably shut off the power line between the battery and the main relay.

### Detailed Description of Embodiment of the Present Disclosure

Specific examples of a power distribution module of the present disclosure will be described below with reference to the drawings. Note that the present disclosure is not limited to these illustrative examples, but is indicated by the claims, and all changes that come within the meaning and range of equivalency of the claims are intended to be embraced therein.

### Embodiment 1

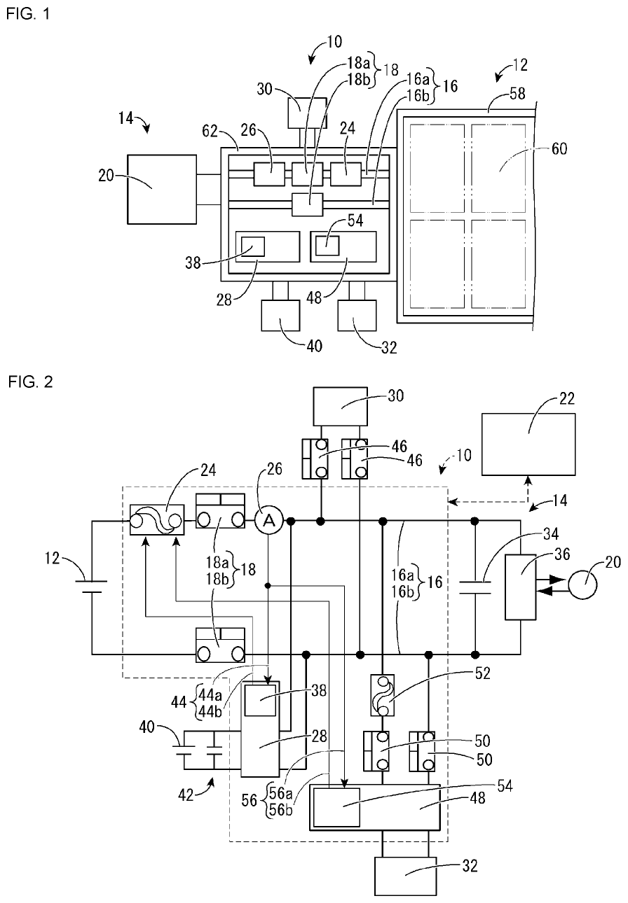

A power distribution module 10 according to Embodiment 1 of the present disclosure is described below with reference to FIGS. 1 and 2. The power distribution module 10 is installed in a vehicle such as an electric car or hybrid car (not shown), for example. As shown in FIGS. 1 and 2, the power distribution module 10 includes power lines 16 that join a battery 12 and a load 14 to each other, and main relays 18 that are respectively connected in series to the power lines 16. Specifically, a main relay 18a is connected to a positive electrode power line 16a and a main relay 18b is connected to a negative electrode power line 16b. Also, power is supplied from the battery 12 to the motor 20 that constitutes the load 14 and causes the vehicle to travel, via the main relay 18a and the main relay 18b. Here, the main relay 18a and the main relay 18b are mechanical relays, and are turned on and off based on a control signal from a vehicle control unit 22 including an ECU and the like. The main relay 18a and the main relay 18b connect the battery 12 and the motor 20 and supply power to the motor 20 when on, and shut off a current between the battery 12 and the motor 20 to stop the supply of power to the motor 20 when off. Note that there may be cases where only some members among a plurality of identical members are given reference numerals while reference numerals are omitted for the other members.

### Power Distribution Module 10

As shown in FIG. 2, the power distribution module 10 is provided with the power lines 16 that include the positive electrode power line 16a and the negative electrode power line 16b. The positive electrode of the battery 12 is connected to the input side of the positive electrode power line 16a, and the negative electrode of the battery 12 is connected to the input side of the negative electrode power line 16b. The positive electrode of the load 14 is connected to the output side of the positive electrode power line 16a and the negative electrode of the load 14 is connected to the output side of the negative electrode power line 16b.

As shown in FIGS. 1 and 2, a pyro fuse 24, which is an active fuse, is connected to the positive electrode power line 16a, on the battery side 12 relative to the main relay 18a that connects the battery 12 and the positive electrode of the load 14 to each other. Also, a current sensor 26, which constitutes an abnormality detection unit, detects the current of the positive electrode power line 16a to detect abnormalities of the power lines 16, is connected to the positive electrode power line 16a on the load 14 side relative to the main relay 18a. Furthermore, in the power distribution module 10, a DC/DC converter 28, which is a first voltage converter, is connected to the positive electrode power line 16a and the negative electrode power line 16b on the load 14 side relative to the main relay 18a and the main relay 18b.

In addition, in the power distribution module 10, a rapid charging power source 30 and a standard charging power source 32 are connected to the positive electrode power line 16a and the negative electrode power line 16b on the load 14 side relative to the main relay 18a and the main relay 18b.

### Battery 12

The battery 12 is formed by a plurality of chargeable secondary cells connected in series, and has a high output voltage of 100 V to 400 V, for example. The current capacity can also be increased by connecting a plurality of secondary cells in parallel. For the secondary cells, lithium ion secondary cells, lithium polymer cells, nickel hydrogen cells, and the like can be used. Also, in place of or in addition to the secondary cells, a capacitor such as an electric double layer capacitor (EDLC) can also be used. In the present specification, secondary cells also include capacitors.

### Load 14

As shown in FIG. 2, the load 14 includes a large-capacity capacitor 34 and a DC/AC inverter 36 that are connected in parallel, for example. Here, the load 14 connects the battery 12 to the motor 20 via the DC/AC inverter 36. The DC/AC inverter 36 converts a DC from the battery 12 to an AC, and supplies the resultant current to the motor 20. Note that, while the motor 20 is performing regenerative braking, the motor 20 serves as a generator that charges the battery 12. In Embodiment 1 of the present disclosure, the DC/AC inverter 36 is used, but a DC/DC converter may be used.

### Pyro Fuse 24

As shown in FIG. 2, the pyro fuse 24 is an active fuse. Here, an active fuse is an element that can be disconnected based on a control signal from an external device. More specifically, the pyro fuse 24 can be disconnected based on a control signal from a later-described first control unit 38 mounted on the DC/DC converter 28 constituting the first voltage converter.

### DC/DC Converter 28

As shown in FIG. 2, the input side of the DC/DC converter 28 that is the first voltage converter is connected to the positive electrode power line 16a and the negative electrode power line 16b on the load 14 side relative to the main relay 18a and the main relay 18b. The output side of the DC/DC converter 28 is connected to, for example, a low-voltage battery 40 formed by a lead power storage cell and a load 42 of the low-voltage battery 40. Accordingly, the low-voltage battery 40 is charged and a voltage is supplied to the load 42 of the low-voltage battery 40 by the battery 12 via the power lines 16 and the DC/DC converter 28.

As shown in FIG. 2, first driving/control wirings 44 extend from the first control unit 38 mounted on the DC/DC converter 28 that is the first voltage converter. The first driving/control wirings 44 include a current value receiving wiring 44a that is connected to the current sensor 26 and receives a current value of the current sensor 26, and a disconnect signal transmission wiring 44b that is connected to the pyro fuse 24 and transmits a disconnect signal to the pyro fuse 24.

### Rapid Charging Power Source 30

As shown in FIG. 2, in the power distribution module 10, the rapid charging power source 30 is connected to the positive electrode power line 16a and the negative electrode power line 16b via relays 46, respectively. By turning on the relays 46 after connecting a high-voltage DC power source to the rapid charging power source 30 using a charging station or the like while the motor 20 is stopped and the main relays 18a and 18b are off, rapid charging of the high-voltage battery 12 is enabled.

### Standard Charging Power Source 32

As shown in FIG. 2, in the power distribution module 10, the output side of an AC/DC converter 48 that is the second voltage converter is connected to the positive electrode power line 16a and the negative electrode power line 16b via relays 50 on the load 14 side relative to the main relay 18a. Note that a fuse 52 is connected in series to the relay 50 on the positive electrode power line 16a side. The standard charging power source 32 is connected to the input side of the AC/DC converter 48. More specifically, after the standard charging power source 32 has been connected to a low AC power source such as a household power source while the motor 20 is stopped and the main relays 18a and 18b are on, turning on the relays 50 allows the standard charging power source 32 to ordinarily charge the high voltage battery 12.

As shown in FIG. 2, a second control unit 54 is connected to the AC/DC converter 48, which is the second voltage converter, and second driving/control wirings 56 extend from the AC/DC converter 48 mounted on the second control 54. The second driving/control wirings 56 include a current value receiving wiring 56a that is connected to the current sensor 26 and receives a current value from the current sensor 26, and a disconnect signal transmission wiring 56b that is connected to the pyro fuse 24 and transmits a disconnect signal to the pyro fuse 24.

Also, as shown in FIG. 1, the battery 12 includes a case 58 that has a rectangular bottomed-box shape that is open upward, and single cells 60 are housed in the case 58. Furthermore, the power distribution module 10 includes a case 62 that has a rectangular bottomed-box shape that is open upward. Also, the power lines 16 formed by bus bars, the main relays 18, the pyro fuse 24, the DC/DC converter 28 on which the first control unit 38 is mounted, the current sensor 26, and the first driving/control wiring 44 are housed in the case 62. Additionally, the AC/AC converter 48 on which the second control unit 54 is mounted, and a second driving/control wiring 56 are housed in the power distribution module 10.

Next, a brief description will be given regarding operation of the power distribution module 10 according to Embodiment 1 of the present disclosure. In Embodiment 1 of the present disclosure, at the start of power supply, the battery 12 and the motor 20 are connected to each other to enable the supply of power to the motor 20. Note that, in the following description, this state is referred to as a normal state where necessary.

In the normal state, when the current value of the current sensor 26 serving as the abnormality detection unit indicates an abnormal value (a current value exceeding a predetermined current value range, for example) and an abnormality of a power line 16 is detected, the first control unit 38 mounted on the DC/DC converter 28 and the second control unit 54 mounted on the DC/DC converter 48 transmit a disconnect signal to the pyro fuse 24. Specifically, the first control unit 38 and the second control unit 54 operate so as to transmit a disconnect signal to the pyro fuse 24 via the disconnect signal transmission wirings 44b and 56b, respectively, in order to disconnect the pyro fuse 24.

With the power distribution module 10 according to the present disclosure structured in this manner, the pyro fuse 24, which is an active fuse, is connected to the positive electrode power line 16a on the battery 12 side relative to the main relay 18a. When the current value of the current sensor 26, which is an abnormality detection unit, indicates an abnormal value and an abnormality of the power line 16 is detected, the first control unit 38 and the second control unit 54 transmit a cut signal to the pyro fuse 24, and the pyro fuse 24 operates to cut itself. Thus, when an abnormality occurs, the positive electrode power line 16a between the battery 12 and the main relay 18a is shut off by the pyro fuse 24. Therefore, a current is not flowing through the positive electrode power line 16a and the negative electrode power line 16b when the main relays 18a and 18b are turned off, and arc discharge can be prevented from occurring between contacts of the main relays 18a and 18b. Thus, an increase in the distance between contacts for arc extinguishment or a specially structured main relay provided with a permanent magnet are not required, and a comparative cheaply main relay can be employed, which reduces the cost.

Also, the first driving/control wirings 44 extend from the first control unit 38 mounted on the DC/DC converter 28, which is the first voltage converter. The first driving/control wirings 44 include the current value receiving wiring 44a that is connected to the current sensor 26 and receives a current value from the current sensor 26, and the cut signal transmission wiring 44b that is connected to the pyro fuse 24 and transmits a cut signal to the pyro fuse 24. Accordingly, receipt of current values from the current sensor 26 and transmission of a cut signal when an abnormality occurs can be performed in the power distribution module 10. Thus, compared to a conventional structure in which it is necessary to route a driving/control wiring between the vehicle control unit 22, the current sensor 26, and the pyro fuse 24, the driving/control wiring can be made shorter. Accordingly, the cost can be reduced, the risk of an issue such as breaking of the driving/control wiring can be advantageously reduced, and the operation reliability of the pyro fuse 24 can also be improved.

Furthermore, operation of the pyro fuse 24 can be controlled using the first control unit 38 mounted on the DC/DC converter 28 that is the first voltage converter, and thus a configuration for controlling operation of the pyro fuse 24 in the power distribution module 10 can be constructed. Thus, the need for adjusting or changing external devices such as the vehicle control unit 22 can be reduced, and a corresponding reduction in cost can be also be achieved. In addition, the power distribution module 10 includes the first driving/control wirings 44 for the pyro fuse 24, and thus, even if an issue was to occur with the vehicle control unit 22, it is possible to cause the pyro fuse 24 to operate when an abnormality on a power line 16 is detected. Thus, the operation reliability of the pyro fuse 24 can be further improved.

Also, the second driving/control wirings 56 extend from the second control unit 54 mounted on the AC/DC converter 48 that is the second voltage converter. The second driving/control wirings 56 include the current value receiving wiring 56a that is connected to the current sensor 26 and receives a current value from the current sensor 26, and the cut signal transmission wiring 56b that is connected to the pyro fuse 24 and transmits a cut signal to the pyro fuse 24. Accordingly, receipt of current values from the current sensor 26 and transmission of a cut signal when an abnormality occurs can also be performed in the power distribution module 10 by the second control unit 54. Thus, even if an issue was to occur with one of the first control unit 38 and the second control unit 54, the pyro fuse 24 can be caused to operate by the other control unit and reliably disconnected when an abnormality occurs on a power line 16. Therefore, the operation reliability of the pyro fuse 24 can be further improved. Furthermore, similarly to the first driving/control wirings 44, the second driving/control wirings 56 extending from the second control unit 54 can be shortened, and thus the risk of breaking and the like occurring can be advantageously reduced.

In addition, the case 62 of the power distribution module 10 of the present disclosure houses the power lines 16, the main relay 18, the pyro fuse 24, the DC/DC converter 28 on which the first control unit 38 is mounted, the current sensor 26, and the first driving/control wirings 44. The case 62 of the power distribution module 10 also houses the AC/DC converter 48 on which the second control unit 54 is mounted and the second driving/control wirings 56. Constituent elements of the power distribution module 10 are housed in the case 62, and thus the handleability of the power distribution module 10 and ease of attaching the power distribution module 10 to a vehicle can be advantageously improved.

Furthermore, the pyro fuse 24 is constituted by an active fuse. Accordingly, when an abnormality of a power line 16 is detected, an explosive force caused by ignition of an explosive can be used to instantaneously and reliably shut off the positive electrode power line 16a between the battery 12 and the main relay 18a. Therefore, a current is not flowing through the positive electrode power line 16a and the negative electrode power line 16b when the main relays 18a and 18b are turned off, and arc discharge can be prevented from occurring between contacts of the main relays 18a and 18b.

### Variations

Embodiment 1 was described as a specific example of the present disclosure, but the present disclosure is not limited to the description of the above specific example. Variations, modifications and the like that achieve the object of the present disclosure are encompassed in the present disclosure. For example, variations of embodiments such as the following are also included in the technical scope of the present disclosure.

(1) In the embodiment, an example was described where the current sensor 26 serves as an abnormality detection unit that detects abnormalities of the power lines 16, but the present disclosure is not limited to this, and the abnormality detection unit may be constituted by a voltage sensor of the like.

(2) In the embodiment, an example was described where the first control unit 38 and the second control unit 54 caused the pyro fuse 24, which is an active fuse, to operate when the current sensor 26 serving as the abnormality detection unit detects an abnormality of a power line 16, but the present disclosure is not limited to this. The pyro fuse 24 may be caused to operate by only one of the first control unit 38 and the second control unit 54 or, furthermore, by a third control unit.

(3) In the embodiment, an example was described where the pyro fuse 24 is an active fuse, but the present disclosure is not limited to this. The pyro fuse 24 may be any element that can be disconnected in response to a signal from an external device. For example, the active fuse may be configured using a metal-oxide-semiconductor field effect transistor (MOSFET).

1. A power distribution module comprising:
a power line connecting between a battery and a load;
a main relay connected to the power line;
an active fuse connected to the power line on the battery side relative to the main relay;
a first voltage converter connected to the power line on the load side relative to the main relay;
an abnormality detection unit configured to detect an abnormality of the power line;
a first driving/control wiring extending from the first voltage converter and connected to the active fuse and the abnormality detection unit; and
a case,
wherein the case houses the power line, the main relay, the active fuse, the first voltage converter, the abnormality detection unit, and the first driving/control wiring, and
a first control unit mounted on the first voltage converter and different from a control unit for controlling the main relay transmits a control signal for disconnecting the active fuse through the first driving/control wiring when the abnormality detection unit detects an abnormality of the power line via the first driving/control wiring, and the active fuse is disconnected.

2. The power distribution module according to claim 1, further comprising:
a second voltage converter connected to the power line on the load side relative to the main relay; and
a second driving/control wiring extending from the second voltage converter and connected to the active fuse,
wherein a second control unit mounted on the second voltage converter transmits a control signal for disconnecting the active fuse when the abnormality detection unit detects an abnormality of the power line, and the active fuse is disconnected.

3. (canceled)

4. The power distribution module according to claim 2, wherein the case further houses the second voltage converter and the second driving/control wiring.

5. The power distribution module according to claim 1, wherein the active fuse is a pyro fuse.

6. The power distribution module according to claim 2, wherein the active fuse is a pyro fuse.

7. The power distribution module according to claim 4, wherein the active fuse is a pyro fuse.
